(19) United States
(12) Patent Application Publication
(10) Pub. No.: US 2024/0068907 A1
(43) Pub. Date: Feb. 29, 2024

(54) OPTIMIZATION ALGORITHM FOR AUTOMATICALLY DETERMINING VARIATIONAL MODE DECOMPOSITION PARAMETERS BASED ON BEARING VIBRATION SIGNALS

(71) Applicant: DALIAN UNIVERSITY OF TECHNOLOGY, Liaoning (CN)

(72) Inventors: Ximing SUN, Dalian (CN); Aina WANG, Dalian (CN); Yingshun LI, Dalian (CN); Pan QIN, Dalian (CN); Chongquan ZHONG, Dalian (CN)

(21) Appl. No.: 18/021,493

(22) PCT Filed: May 11, 2022
(86) PCT No.: PCT/CN2022/092093

§ 371 Date: Sep. 28, 2023

(30) Foreign Application Priority Data
Mar. 23, 2022 (CN) 202210285394.4

(51) Int. Cl. G01M 13/045; G06N 3/126

(52) U.S. Cl. CPC G01M 13/045; G06N 3/126

(57) ABSTRACT

The present invention provides an optimization algorithm for automatically determining variational mode decomposition parameters based on bearing vibration signals. First, mode energy is used to reflect bandwidth, a bandwidth optimization sub-model is established to automatically obtain optimal bandwidth parameter αₒₚₜ. Secondly, energy loss optimization sub-model is established to avoid under-decomposition. Thirdly, a mode mean position distance optimization sub-model is established to prevent the generation of too much K and avoid the phenomenon of over-decomposition. Finally, considering the interaction between the bandwidth parameter α and the total number of modes K, the interaction between mode components and the integrity of reconstruction information, nonlinear transformation is performed by a logarithmic function, so as to make the values of three optimization sub-models form similar scales, obtain an optimization model that can automatically determine optimal VMD parameters αₒₚₜ and Kₒₚₜ, and establish a quantitative evaluation index for the decomposition performance of a VMD algorithm.

### TECHNICAL FILED

The present invention belongs to the technical field of signal decomposition, and relates to an optimization algorithm based on automatic determination of variational mode decomposition parameters.

### BACKGROUND

Bearings play a vital role in the reliable and stable operation of rotating machinery, and vibration signals are characterized by being easy to collect and containing a large amount of information on the health status of mechanical equipment. Therefore, an effective bearing fault diagnosis method based on vibration signals is crucial to the health management of rotating machinery. However, the original vibration signals collected in practical engineering applications often contain rich, dynamic and noisy data, which makes the signals unsuitable for direct use in failure mode identification. Therefore, a signal decomposition method is needed to reduce the complexity of the original bearing vibration signals and extract effective feature information that can characterize the health status of a bearing, so as to improve the failure mode identification ability of a final bearing classification process.

At present, for signal decomposition methods, wavelet decomposition, empirical mode decomposition and ensemble empirical mode decomposition are several typical methods, all of which have been successfully applied. However, the wavelet decomposition depends on the selection of wavelet basis; the empirical mode decomposition has the disadvantages of endpoint effect and mode mixing; and the ensemble empirical mode decomposition has the problems of error accumulation and large amount of calculation.

VMD is a completely non-recursive and adaptive signal decomposition algorithm that decomposes non-stationary or nonlinear signals into a series of narrowband mode components IMF. However, the application of the VMD algorithm is limited by the selection of a bandwidth parameter α and the number of modes K. The current research focuses on how to select the two parameters α and K, but several problems still exist: 1) one of the parameters is optimized alone, that is, only α or K is considered alone; 2) the effects of the two parameters are ignored, and no optimization is performed at the same time; 3) the distance between a reconstructed mode and an original signal is ignored; 4) interactions between modes are ignored.

Due to the existence of the above problems, the mode components obtained by the signal decomposition algorithm VMD have negative effects on subsequent feature parameter extraction of bearing vibration signals and identification of bearing failure modes.

### SUMMARY

In view of the above-mentioned problems in the prior art, the purpose of the present invention is to provide an optimization algorithm that can automatically determine optimal VMD parameters (αₒₚₜ and Kₒₚₜ) according to specific features of bearing vibration signals, use the VMD to reasonably decompose the bearing vibration signals based on the optimal parameters to obtain a group of mode components uₖ(k=1,2, . . . K), also denoted as IMF, extract effective feature information that can characterize the health status of the bearing based on the obtained group of mode components, and then provide key information for the failure mode identification of the bearing.

To achieve the above purpose, the present invention adopts the following technical solution:

An optimization algorithm for automatically determining variational mode decomposition parameters based on bearing vibration signals, comprising the following steps:
(1) Establishing a bandwidth optimization sub-model to obtain an optimal bandwidth parameter αₒₚₜ

The bandwidth of a mode is related to the bandwidth parameter α. If the bandwidth parameter α is large, a small bandwidth will be obtained, and otherwise, a large bandwidth will be obtained. The bandwidth and energy are positively correlated, and the signal self-power spectral density represents the energy of a signal, so the energy of the mode can be measured by the self-power spectral density, and then the bandwidth of the mode can be calculated to obtain the optimal bandwidth parameter αₒₚₜ.

The steps for obtaining the bandwidth by the Self-Power Spectral Density (SPSD) of the mode are as follows:
1) Decomposing a signal into K modes uₖ(k=1,2, . . . K) by a classic VMD algorithm and parameter configurations (K and α).
2) Selecting the k^{th} mode uₖ to explain how to use SPSD to estimate the bandwidth. According to equation (1):

$$\{ \begin{matrix}SPS {D}_{k 1} = {\int }_{0}^{{f}_{k 1}} {\vert {u}_{k} ( f ) \vert}^{2} d f = 0.005 {\int }_{0}^{{f}_{k}} {\vert {u}_{k} ( f ) \vert}^{2} d f \\ SPS {D}_{k 2} = {\int }_{0}^{{f}_{k 2}} {\vert {u}_{k} ( f ) \vert}^{2} d f = 0.995 {\int }_{0}^{{f}_{k}} {\vert {u}_{k} ( f ) \vert}^{2} d f \\ SPS {D}_{k} = S P S {D}_{k 2} - S P S {D}_{k 1}\end{matrix} \qquad ( 1 )$$

The self-power spectral density SPSDₖ of the k^{th} mode uₖ can be obtained. Where SPSDₖ₁ and fₖ₁ are respectively the first 0.5% SPSD values of the mode and a corresponding frequency point; SPSDₖ₂ and fₖ₂ are respectively the last 0.5% SPSD values of the mode and a corresponding frequency point.

Then the analyzed bandwidth BWₖ of the mode uₖ is:

BWₖ=fₖ₂−fₖ₁,k=1,2, . . . K (2)

According to equation:

$$\{ \begin{matrix}{min}_{\{ {u}_{k} \} , \{ {ω}_{k} \}} & \{ {\sum }_{k = 1}^{K} {‖ {\partial }_{t} [ ( δ ( t ) + \frac{j}{π t} ) * {u}_{k} ( t ) ] {e}^{j {ω}_{k} t} ‖}_{2}^{2} \} \\ s . t . & {\sum }_{k = 1}^{K} {u}_{k} = x ( t )\end{matrix} \qquad ( 3 )$$

The signal can be decomposed into several principal modes, and the sum of the bandwidths of each IMF is considered to be minimum. Where K is the total number of modes, x(t) is an original signal to be decomposed, δ(t) is a Dirac distribution, and * is a convolution operator. A corresponding analytic signal uₖ(t) is calculated by Hilbert transform to obtain a unilateral frequency spectrum. Subsequently, the frequency of the mode is translated to a baseband by the displacement property of Fourier transform, the bandwidth of the mode is obtained through the L²square of a −norm of gradient, and {uₖ|k=1,2, . . . K} {ωₖ|k=1,2, . . . K} are respectively a set of all modes and the corresponding center frequencies.

Therefore, a bandwidth optimization model is obtained:

$${min}_{α} BW = {‖ {f}_{2} - {f}_{1} ‖}_{2}^{2} \qquad ( 4 )$$

Where BW represents the sum of the bandwidths of all modes, f₁=[f₁₁ f₂₁ . . . f_{K1}]^{T} is the left frequency point of all modes uₖ(k=1,2, . . . K), K is the number of modes obtained by decomposition, and f₂=[f₂₁ f₂₂ . . . f_{K2}]^{T} is the right frequency point. For example, f₁₁ represents the frequency point of the first 0.5% self-power spectral density of the first mode, that is, the left frequency point of the first mode; f₁₂ represents the frequency point of the last 0.5% self-power spectral density of the first mode, that is, the right frequency point of the first mode.
(2) Establishing an energy loss optimization sub-model

If the number of modes is too small, under-decomposition will occur, and under-decomposition will cause a residual signal to contain more information of the original signal, resulting in a relatively large distance between the reconstructed signal and the original signal of the mode. To avoid under-decomposition and ensure the integrity of mode reconstruction information, which can be achieved by controlling the energy loss of the residual signal, an energy loss optimization sub-model is established:

$${min}_{K} Res = {‖ x ( t ) - {\sum }_{k = 1}^{K} {u}_{k} ( t ) ‖}_{2}^{2} \qquad ( 5 )$$

Where Res represents residual energy; and

$${\sum }_{k = 1}^{K} {u}_{k} ( t )$$

represents a mode reconstruction signal.
(3) Establishing a mode mean position distance optimization sub-model:

Excessive number of modes will lead to over-decomposition, over-decomposition will lead to aliasing of adjacent modes, resulting in an aliasing area, and over-decomposition may also include redundant noise. According to

$${ω}_{k}^{n + 1} ← \frac{{\int }_{0}^{∞} ω {\vert {\hat{u}}_{k} ( ω ) \vert}^{2} d ω}{{\int }_{0}^{∞} {\vert {\hat{u}}_{k} ( ω ) \vert}^{2} d ω} ,$$

the center frequency ωₖ of the mode uₖ can characterize the position thereof in a frequency domain, and ûₖ(ω) represents a mode component in a corresponding spectral domain, so the area of corresponding mode aliasing is related to the distance from the corresponding center frequency. To prevent the generation of too much K and avoid the occurrence of over-decomposition, which can be achieved by controlling the distance from the center frequency of the mode, a mode mean position distance optimization sub-model is established:

$${max}_{K} {Δω}_{K} = \frac{1}{K - 1} {\sum }_{k = 1}^{K - 1} {\vert {ω}_{k + 1} - {ω}_{k} \vert}^{2} \qquad ( 6 )$$

Where Δω_{K} represents a mode mean position distance, ω_{K+1} represents the center frequency of the latter mode in adjacent modes, and ω_{K} represents the center frequency of the first mode in the adjacent modes.
(4) Obtaining an optimal mode number Kₒₚₜ by considering the energy loss optimization sub-model and the mean position distance optimization sub-model comprehensively.

Whether the total number of modes is too large or too small, the decomposition of the signal will be adversely affected. To select an appropriate total number of modes, it is not only necessary to ensure that the total number of decomposed modes is not too small to cause under-decomposition, that is, to avoid the occurrence of energy loss, but also necessary to ensure that the total number of modes is not too large to cause over-decomposition, that is, to avoid the occurrence of mode aliasing; by comprehensively considering the energy loss optimization sub-model and the mean position distance optimization sub-model:

$${min}_{K} {K}_{num} = {‖ x ( t ) - {\sum }_{k = 1}^{K} {u}_{k} ( t ) ‖}_{2}^{2} - \frac{1}{K - 1} {\sum }_{k = 1}^{K - 1} {\vert {ω}_{k + 1} - {ω}_{k} \vert}^{2}$$

An optimal mode number Kₒₚₜ can be obtained; where Kₙᵤₘ represents an objective function of an optimized mode number optimization model.
(5) To obtain the optimal VMD parameters αₒₚₜ and Kₒₚₜ of a bearing signal to be decomposed at the same time, it is necessary to consider the interaction between the bandwidth parameter α and the total number of modes K, the interaction between mode components and the integrity of reconstruction information, so the three optimization sub-models of the above step (1)-step (3) need to be satisfied at the same time. As the bandwidth optimization sub-model, the energy loss optimization sub-model and the mean position distance optimization sub-model have a relatively large order of magnitude difference, nonlinear transformation is performed to the three optimization sub-models by a logarithmic function, so as to make the values of the three optimization sub-models form similar scales, and obtain an optimization model that can automatically determine the VMD parameters αₒₚₜ and Kₒₚₜ;

$${max}_{( K , α )} OMD = ln ( \frac{1}{K - 1} {\sum }_{k = 1}^{K - 1} {\vert {ω}_{k + 1}^{n + 1} - {ω}_{k}^{n + 1} \vert}^{2} ) - ln ( {‖ {f}_{2} - {f}_{1} ‖}_{2}^{2} ) - ln ( {‖ x ( t ) - {\sum }_{k = 1}^{K} {u}_{k} ( t ) ‖}_{2}^{2} ) \qquad ( 7 )$$

Where OMD represents an objective function.

The optimal parameter configurations (αₒₚₜ and Kₒₚₜ) automatically determined by the optimization model can ensure that the decomposition algorithm VMD has both good decomposition performance and high reconstruction accuracy.
(6) Using a genetic algorithm-based solver to solve the optimization model in step (5), and automatically determine the optimal VMD parameters αₒₚₜ and Kₒₚₜ.

$$\begin{matrix}{max}_{( K , α )} & OMD\end{matrix} \qquad ( 8 )$$

$$\begin{matrix}s . t . & K ∈ {R}_{K} ⊂ N \\ & α ∈ {R}_{α} ⊂ N\end{matrix}$$

Where R_{K} and R_{α} are respectively the value ranges of K and α, and N is a set of nonnegative integers. Based on the obtained optimal parameters αₒₚₜ and Kₒₚₜ, the bearing vibration signals can be decomposed reasonably, which provides a basis for feature extraction and fault diagnosis based on the bearing vibration signals.

Further, the setting of the genetic algorithm in step (6) is:
1) Search space: a search space S⊂R_{K}×R_{α} is obtained based on the VMD parameter configurations α and K, and an individual sⱼ=(Kⱼ,αⱼ)∈S in a population is obtained by binary encoding.
2) Fitness function: fitness of each individual sⱼ∈S is evaluated by the value of the objective function OMD in equation (7), and is denoted by rⱼ.
3) Genetic operator: an optimal solution is obtained through iterative operations such as selection, crossover and mutation.

The probability Pⱼ of each individual sⱼ being selected is obtained by sorting selection:

$${P}_{j} = {P}_{min} + ( {P}_{max} - {P}_{min} ) \frac{j - 1}{n - 1} ,$$

$$where {P}_{min} = min \{ {P}_{j}^{*} \vert j = 1 , 2 , … n \} , {P}_{max} = max \{ {P}_{j}^{*} \vert j = 1 , 2 , … n \} , {P}_{j}^{*} = \frac{{r}_{j}}{{\sum }_{j = 1}^{n} {r}_{j}} ,$$

P*ⱼ represents the original probability of the fitness rⱼ of the individual sⱼ being selected, and n is a population size.

The crossover probability P_{c} is:

$${P}_{c} = \{ \begin{matrix}{P}_{c max} - ( {P}_{c max} - {P}_{c min} ) \frac{{r}_{max} - {r}_{j}}{{r}_{max} - {r}_{avg}} , & {r}_{cj} \geq {r}_{avg} \\ {P}_{c max} , & {r}_{cj} < {r}_{avg}\end{matrix}$$

P_{cmax} and P_{cmin} represent the lower limit and upper limit of the crossover probability respectively, r_{avg} is an average fitness of individuals in the population of the present genetic generation, r_{cj} is the larger fitness value of two individuals to be crossed over, and rₘₐₓ is the maximum fitness of individuals in the population of the present genetic generation.

The mutation probability Pₘ is:

$${P}_{m} = \{ \begin{matrix}{P}_{m max} - ( {P}_{m max} - {P}_{m min} ) \frac{{r}_{max} - {r}_{j}}{{r}_{max} - {r}_{avg}} , & {r}_{mj} \geq {r}_{avg} \\ {P}_{m max} , & {r}_{mj} < {r}_{avg}\end{matrix}$$

Pₘₘₐₓ and Pₘₘᵢₙ represent the lower limit and upper limit of the mutation probability respectively, where rₘⱼ is the fitness of a mutated individual.
(7) Establishing a quantitative evaluation index J of VMD decomposition performance to quantitatively evaluate the decomposition performance of the VMD algorithm to decompose the bearing vibration signals:

$$J = \frac{{‖ {f}_{2} - {f}_{1} ‖}_{2}^{2} \cdot {‖ x ( t ) - {\sum }_{k = 1}^{K} {u}_{k} ( t ) ‖}_{2}^{2}}{\frac{1}{K - 1} {\sum }_{k = 1}^{K - 1} {\vert {ω}_{k + 1} - {ω}_{k} \vert}^{2}} \qquad ( 9 )$$

Where the smaller ∥f₂−f₁∥₂² is, the narrower the decomposition bandwidth is; the smaller

$${‖ x ( t ) - {\sum }_{k = 1}^{K} {u}_{k} ( t ) ‖}_{2}^{2}$$

is, the smaller the residual energy is, and the smaller the distance between a reconstructed mode and the original signal is, that is, the higher the reconstruction degree is; the larger

$$\frac{1}{K - 1} {\sum }_{k = 1}^{K - 1} {\vert {ω}_{k + 1} - {ω}_{k} \vert}^{2}$$

is, the farther the distance between adjacent mode centers is, and the smaller the aliasing area between the adjacent modes is. The ideal result of signal decomposition by the VMD algorithm is to decompose the signals to be decomposed into several narrow-bandwidth signals without aliasing but with complete information. Therefore, the smaller the quantitative evaluation index J of VMD decomposition performance is, the better the VMD decomposition performance is.

By adopting the above-mentioned technology, compared with the prior art, the present invention has the following beneficial technical effects:

The optimization model established by the present invention considers the interaction between the bandwidth parameter α of the signal decomposition algorithm VMD and the total number of modes K, the interaction between mode components and the integrity of reconstruction information. Moreover, the technology of the present invention can automatically obtain the optimal VMD parameters (αₒₚₜ and Kₒₚₜ) by solving the optimization model by a GA-based solver for specific bearing signals. Based on the obtained group of optimal decomposition parameters, the original bearing vibration signals can be reasonably decomposed by VMD, and a group of ideal mode components can be obtained, that is, no mode aliasing, under-decomposition or over-decomposition phenomenon occurs. Based on the obtained group of ideal mode components, the present invention provides a basic guarantee for the subsequent extraction of effective feature information that characterizes the health status of the bearing and the improvement of the bearing failure mode identification ability.

### DESCRIPTION OF DRAWINGS

FIG. 1 is a schematic diagram of bandwidth estimation and center frequency distance estimation of an artificial bearing vibration signal according to an embodiment of the present invention.

FIG. 2 is a flow chart of solving an optimization model by a genetic algorithm-based solver according to an embodiment of the present invention.

FIG. 3 is a time-frequency diagram of a noiseless artificial bearing vibration signal of an embodiment of the present invention, wherein (a) is a time-domain waveform diagram of the signal, and (b) is a frequency spectrum of the signal.

FIG. 4 is a schematic diagram of distribution of OMD according to the changes of α and K values in the process of decomposing and optimizing a noiseless artificial bearing vibration signal according to an embodiment of the present invention.

FIG. 5 is a decomposition result diagram of decomposing a noiseless artificial bearing vibration signal by adopting optimal parameters αₒₚₜ and Kₒₚₜ obtained by VMD in an embodiment of the present invention, wherein (a) is a time-domain waveform diagram of the signal, (a1)-(a4) are respectively time-domain waveform diagrams of IMF1-IMF4, (b) is a frequency spectrum of the signal, and (b1)-(b4) are respectively frequency spectra of IMF1-IMF4.

FIG. 6 is a time-frequency diagram of an artificial bearing vibration signal added with Gaussian white noise according to an embodiment of the present invention, wherein (a) is a time-domain waveform diagram of the signal, and (b) is a frequency spectrum of the signal.

FIG. 7 is a schematic diagram of distribution of OMD according to the changes of α and K values in the process of optimizing an artificial bearing vibration signal added with Gaussian white noise according to an embodiment of the present invention.

FIG. 8 is a decomposition result diagram of decomposing a bearing vibration signal added with Gaussian white noise by adopting optimal parameters αₒₚₜ and Kₒₚₜ obtained by VMD in an embodiment of the present invention, wherein (a) is a time-domain waveform diagram of the signal, (a1)-(a4) are respectively time-domain waveform diagrams of IMF1-IMF4, (b) is a frequency spectrum of the signal, and (b1)-(b4) are respectively frequency spectra of IMF1-IMF4.

FIG. 9 is a time-frequency of a group of bearing inner ring vibration signals of a CWRU laboratory public data set according to an embodiment of the present invention, wherein (a) is a time-domain waveform diagram of the signals, and (b) is a frequency spectrum of the signals.

FIG. 10 is a schematic diagram of distribution of OMD according to the changes of α and K values in the process of optimizing a group of bearing inner ring vibration signals of a CWRU laboratory public data set according to an embodiment of the present invention.

FIG. 11 is a decomposition result diagram of decomposing a group of bearing inner ring vibration signals of a CWRU laboratory public data set by adopting optimal parameters αₒₚₜ and Kₒₚₜ obtained by VMD in an embodiment of the present invention, wherein (a) is a time-domain waveform diagram of the signals, (a1)-(a4) are respectively time-domain waveform diagrams of IMF1-IMF4, (b) is a frequency spectrum of the signals, and (b1)-(b4) are respectively frequency spectra of IMF1-IMF4.

### DETAILED DESCRIPTION

The present invention will be further described in detail below in combination with the drawings:

An optimization algorithm based on automatic determination of variational mode decomposition parameters of the present invention is mainly aimed at the problems existing in the parameter optimization of the VMD algorithm in the prior art: 1) one of the parameters is optimized alone, that is, only α or K is considered alone; 2) the effects of the two parameters are ignored, and no optimization is performed at the same time; 3) the distance between a reconstructed mode and an original signal is ignored; 4) interactions between modes are ignored. Due to the existence of the above problems, the mode components obtained by decomposition are unreasonable, which has an adverse effect on subsequent bearing feature information extraction and failure mode identification. The optimization model established by the present invention considers the interaction between the bandwidth parameter α and the total number of modes K, the interaction between mode components and the integrity of reconstruction information, so the optimization model is solved by the present invention by the GA-based solver, at the same time, the original bearing vibration signals can be reasonably decomposed by the automatically obtained optimal VMD parameters, and a group of mode components can be obtained. Based on the obtained set of ideal modes, the present invention provides a basic guarantee for the subsequent extraction of effective feature information that characterizes the health status of the bearing and the improvement of the bearing failure mode identification ability.

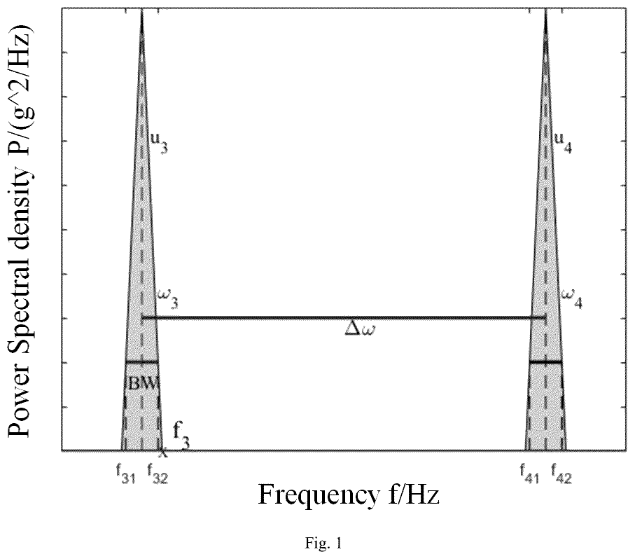

The present invention uses artificial bearing vibration signals to illustrate how to use SPSD to estimate mode bandwidth and provides a schematic diagram of the distance between center frequencies of adjacent modes. FIG. 1 shows a frequency spectrum of modes u₃ and u₄ obtained by decomposing the artificial bearing vibration signals x₁(t)=sin(2π·30·t)+sin(2π·80·t)+sin(2π·100·t)+sin(2π·150·t) by VMD, and the bandwidth BW3 of the mode u₃ estimate by SPSD in a frequency domain:
1) Based on the parameter configurations (K and α), an artificial bearing vibration signal x₁(t) is decomposed into K modes uₖ(k=1,2, . . . 4) by a classic VMD algorithm.
2) Selecting the 3^{rd} mode u₃ to explain how to use SPSD to estimate the bandwidth. According to equation:

$$\{ \begin{matrix}{SPSD}_{31} & = {\int }_{0}^{{f}_{31}} {\vert {u}_{3} ( f ) \vert}^{2} df = 0. 005 {\int }_{0}^{{f}_{3}} {\vert {u}_{3} ( f ) \vert}^{2} df \\ {SPSD}_{32} & = {\int }_{0}^{{f}_{32}} {\vert {u}_{3} ( f ) \vert}^{2} df = 0. 995 {\int }_{0}^{f 3} {\vert {u}_{3} ( f ) \vert}^{2} df \\ {SPSD}_{3} & = {SPSD}_{32} - {SPSD}_{31}\end{matrix}$$

The self-power spectral density SPSD₃ of the 3^{rd} mode u₃ can be obtained. Where SPSD₃₁ and f₃₁ are respectively the first 0.5% SPSD values of the 3^{rd} mode u₃ and a corresponding frequency point; SPSD₃₂ and f₃₂ are respectively the last 0.5% SPSD values of the mode and a corresponding frequency point.

Then the analyzed bandwidth BW₃ of the mode u₃ is:

BW₃=f₃₂−f₃₁,

The center frequencies of the adjacent modes u₃ and u₄ shown in FIG. 1 are ω₃ and ω₄ respectively, and the distance between center frequencies is ω₃-ω₄. A larger distance between center frequencies can alleviate the aliasing of the adjacent modes. Therefore, by optimizing the distance between center frequencies:

$${max}_{K} {Δω}_{K} = \frac{1}{K - 1} {\sum }_{k = 1}^{K - 1} {\vert {ω}_{k + 1} - {ω}_{k} \vert}^{2} ,$$

The aliasing area can be reduced, thereby avoiding the occurrence of over-decomposition.

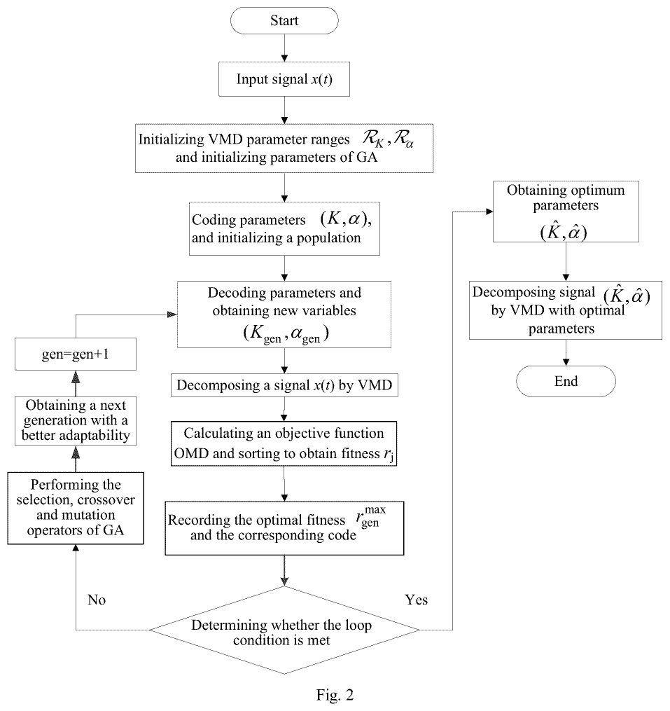

FIG. 2 shows a flow chart of solving the optimization model of the present invention by a genetic algorithm-based solver of the present invention and automatically determining optimal VMD parameters αₒₚₜ and Kₒₚₜ, which comprises the following steps:
1) Initializing VMD parameters ranges R_{K} and R_{α};
2) Initializing genetic algorithm parameters;
3) Conducting binary encoding to the parameters α and K;
4) Initializing a while loop iteration to gen=1;
5) Entering a while loop;
6) Decoding the parameters α and K, and assigning the obtained new parameters (K_{gen} and α_{gen});
7) Using VMD to decompose the signal to be decomposed;
8) Calculating the objective function OMD of each individual in the present genetic generation gen, and sorting to obtain the fitness rⱼ;
9) Recording the best fitness r_{gen}^{max} and the corresponding code;
10) Performing the selection, crossover and mutation genetic operators of the genetic algorithm;
11) Obtaining a next generation with a better adaptability;
12) gen=gen+1;
13) Determining whether the loop condition is met, repeating steps 6)-12), and otherwise going to step 14);
14) Returning the maximum fitness rₘₐₓ in all genetic generations, and obtaining the optimal parameters (αₒₚₜ and Kₒₚₜ);
15) Based on the obtained optimal parameters (αₒₚₜ and Kₒₚₜ), reasonably decomposing the signal to be decomposed by VMD and obtaining Kₒₚₜ modes.

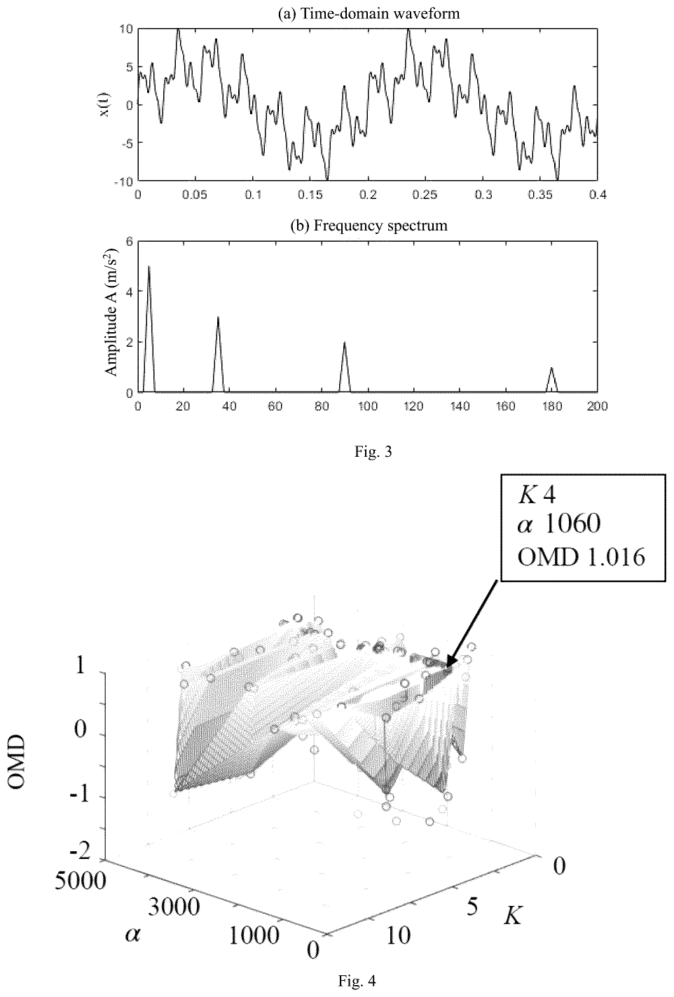

FIG. 3 shows (a) a time-domain waveform diagram and (b) a frequency spectrum of a noiseless artificial bearing vibration signal x(t)=5 sin(2π·30·t)+3 sin(2π·80·t)+2 sin(2π·100·t)+sin(2π·150·t) to be decomposed in an embodiment of the present invention;

FIG. 4 shows a schematic diagram of distribution of OMD according to the changes of α and K values in the process of decomposing and optimizing a noiseless artificial bearing vibration signal x(t) according to an embodiment of the present invention. From the distribution of the fitness value OMD with the changes of α and K values, it can be seen that in the process of solving the optimization model (8) by the genetic algorithm-based solver and automatically determining the optimal VMD parameters (αₒₚₜ and Kₒₚₜ) that decompose the noiseless artificial bearing vibration signal x(t), (K, α, OMD)=(4, 1016, 1.016) is the finally obtained optimal point, the result values around the optimal point are produced by the last few iterations and eventually tend to be stable without changes, and the optimal VMD parameters (αₒₚₜ and Kₒₚₜ) that decompose the artificial bearing vibration signal x(t) are obtained, which proves that in the process of solving the optimization model by the genetic algorithm, the optimal parameters (α, K)=(1016, 4) that decompose the signal x(t) shown in FIG. 3 is gradually converged and obtained.

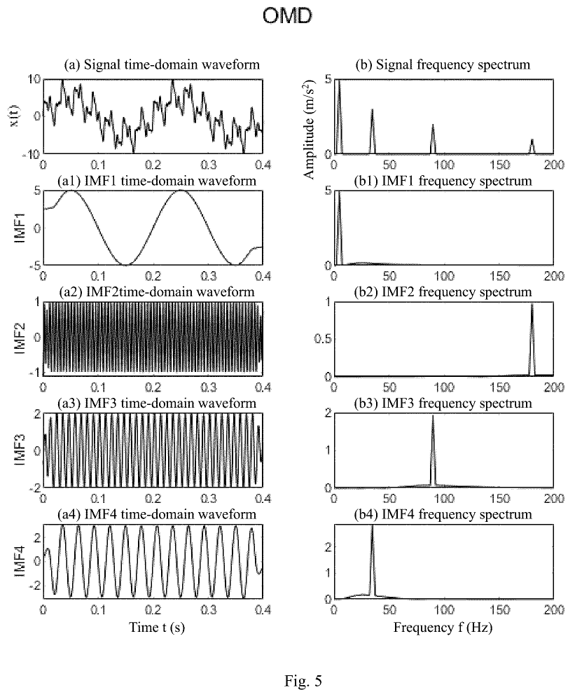

FIG. 5 is a result diagram of decomposing the noiseless artificial bearing vibration signal x(t) shown in FIG. 3 by the optimal VMD parameters (α, K)=(1016, 4). It can be seen from the figure that the time-domain waveform diagrams of the original signal x(t) and the mode IMF1-IMF4 obtained by decomposition are shown in the left of the figure, the corresponding frequency spectra are shown in the right of the figure, and no under-decomposition or over-decomposition phenomenon exist in the decomposition results, which indicates that using the variational mode decomposition parameters determined by the optimization algorithm to decompose the noiseless artificial bearing vibration signal x(t) of the embodiment of the present invention, an ideal decomposition result is obtained.

The decomposition results of the noiseless artificial bearing vibration signal x(t) shown in FIG. 3 are evaluated by a quantitative evaluation index J of VMD decomposition performance, and the quantitative evaluation results are shown in Table 1.

TABLE 1
Comparison of quantitative indexes of decomposition performance
for noiseless artificial bearing vibration signal

| | | Mode mean | |
|---|---|---|---|
| | | position | Comprehensive |
| | Energy | distance | evaluation |
| Algorithm index | loss Res | Δω_{K} | index J |
| Traditional VMD | 2.9165 | 1.3917e+04 | 1.315 |
| Optimal VMD algorithm | 41.0190 | 7225 | 142.806 |
| MMEE-VMD using minimum | | | |
| mean envelope entropy as | | | |
| optimization model | | | |
| The optimization algorithm | 1.6689 | 1.3917e+04 | 0.989 |
| OMD-VMD of the patent of | | | |
| the present invention | | | |

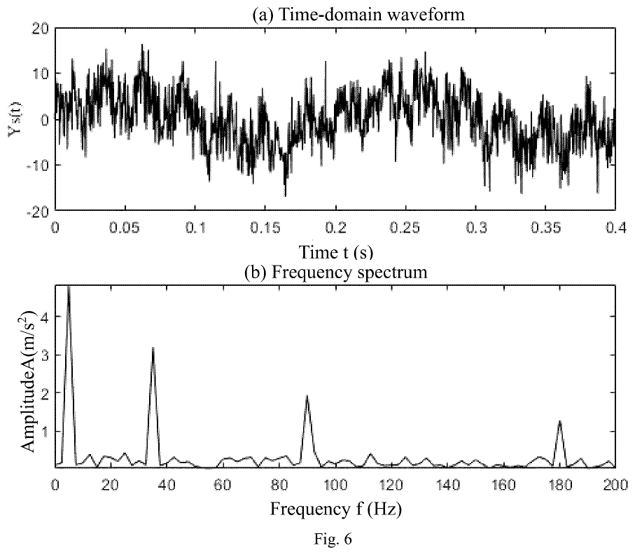

FIG. 6 is a time-frequency diagram of an artificial bearing vibration signal Yₛ(t)=5 sin(2π·30·t)+3 sin(2π·80·t)+2 sin(2π·100·t)+sin(2π·150·t)+η(0, σ) added with Gaussian white noise, wherein η(0, σ) means adding Gaussian white noise with a mean value of 0 and a standard deviation of σ. In FIG. 6, (a) is a time-domain waveform diagram of the signal, (b) is a frequency spectrum of the signal, and the Noise Signal Ratio (NSR) of the noise signal is 44.1%,

NSR=Pₙₒᵢₛₑ/P_{signal}×100% (unit: %),
Pₙₒᵢₛₑ is a noise power, and P_{signal} is a signal power.

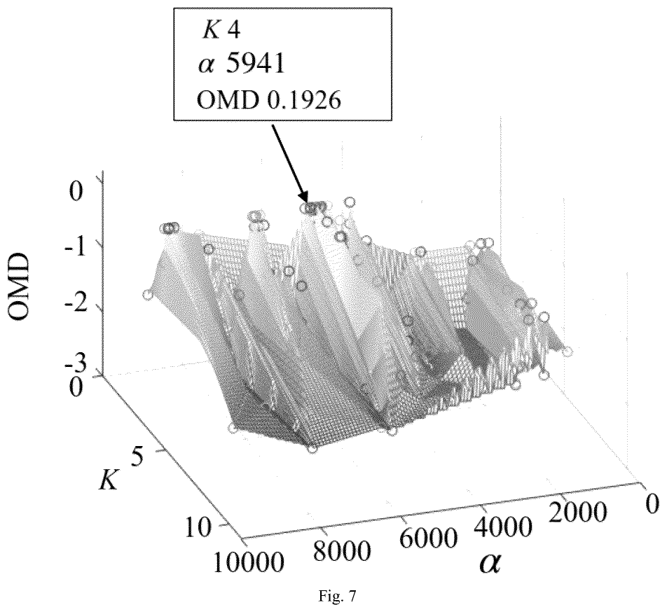

FIG. 7 shows a schematic diagram of distribution of OMD according to the changes of α and K values in the process of decomposing and optimizing an artificial bearing vibration signal Yₛ(t) added with Gaussian white noise shown in FIG. 6. From the distribution of the fitness value OMD with the changes of α and K values, it can be seen that in the process of solving the optimization model (8) by the genetic algorithm-based solver and automatically determining the optimal VMD parameters (αₒₚₜ and Kₒₚₜ) that decompose the noise-added artificial bearing vibration signal Yₛ(t), (K, α, OMD)=(4, 5941, 0.1926) is the optimal point, the result values around the optimal point are produced by the last few iterations and eventually tend to be stable without changes, and the optimal VMD parameters (αₒₚₜ and Kₒₚₜ) that decompose the noise-added artificial bearing vibration signal Yₛ(t) are obtained, which proves that in the process of solving the optimization model by the genetic algorithm, the optimal parameters (α, K)=(5941, 4) that decompose the noise-added artificial bearing vibration signal Yₛ(t) shown in FIG. 6 is gradually converged and obtained.

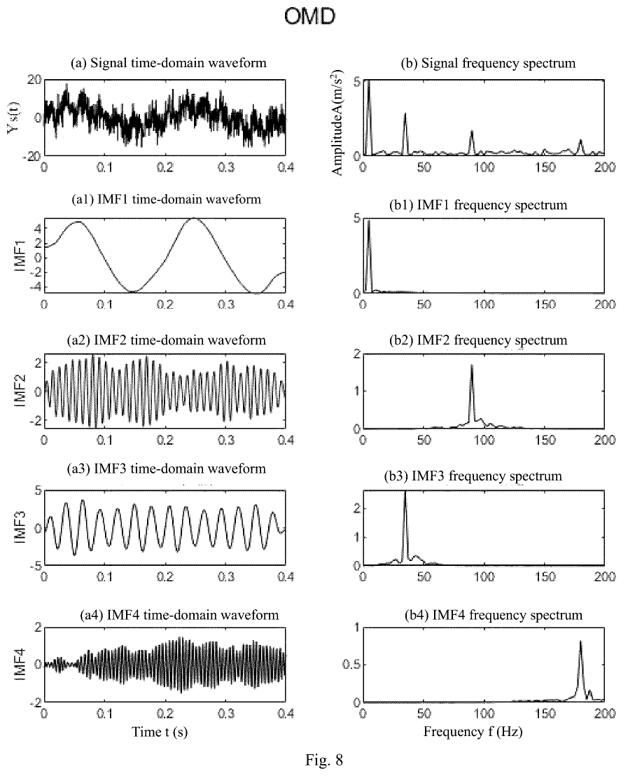

FIG. 8 shows a result diagram of decomposing the noise-added artificial bearing vibration signal Yₛ(t) shown in FIG. 6 by the optimal VMD parameters (α, K)=(5941, 4). It can be seen from the figure that the time-domain waveform diagrams of the original noise-added artificial bearing vibration signal Yₛ(t) and the intrinstic modes IMF1-IMF4 obtained by decomposition are shown in the left of the figure, the corresponding frequency spectra are shown in the right of the figure, and no under-decomposition or over-decomposition phenomenon exist in the decomposition results, which indicates that using the variational mode decomposition parameters determined by the optimization algorithm to decompose the noise-added artificial bearing vibration signal Yₛ(t) of the embodiment of the present invention, an ideal decomposition effect is obtained.

To further illustrate the robustness of the optimization algorithm against noise signals, OMD-VMD is used to decompose the noise-added bearing vibration signals with different noise scales. The quantitative indexes of the decomposition results are shown in Table 2.

TABLE 2
Comparison of quantitative evaluation indexes of
noise-added bearing vibration signals with different
noise scales based on OMD-VMD decomposition

| Serial No. | NSR | BW | Res | Δω_{K} | J |
|---|---|---|---|---|---|
| 1 | 44.1 | 2.6428e+03 | 95.8088 | 1.3917e+04 | 18.195 |
| 2 | 10 | 2.8429e+03 | 58.2009 | 1.3917e+04 | 11.889 |
| 3 | 8 | 2.9637e+03 | 53.5183 | 1.3917e+04 | 11.397 |
| 4 | 6 | 3.0729e+03 | 49.0123 | 1.3917e+04 | 10.822 |
| 5 | 4 | 3.1223e+03 | 40.2493 | 1.3917e+04 | 9.030 |
| 6 | 2 | 3.2213e+03 | 34.0786 | 1.3917e+04 | 7.888 |
| 7 | 1 | 3.6253e+03 | 27.9164 | 1.3917e+04 | 7.272 |
| 8 | 0 | 8.2481e+03 | 1.6689 | 1.3917e+04 | 0.989 |

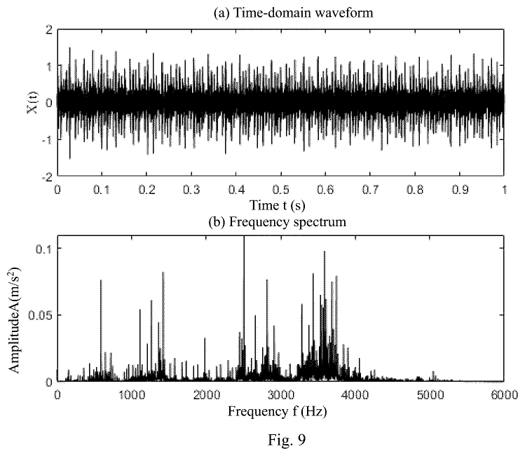

FIG. 9 shows a time-frequency of a group of bearing inner ring vibration signals X(t) of a CWRU laboratory public data set, wherein (a) is a time-domain waveform diagram of the signals, and (b) is a frequency spectrum of the signals.

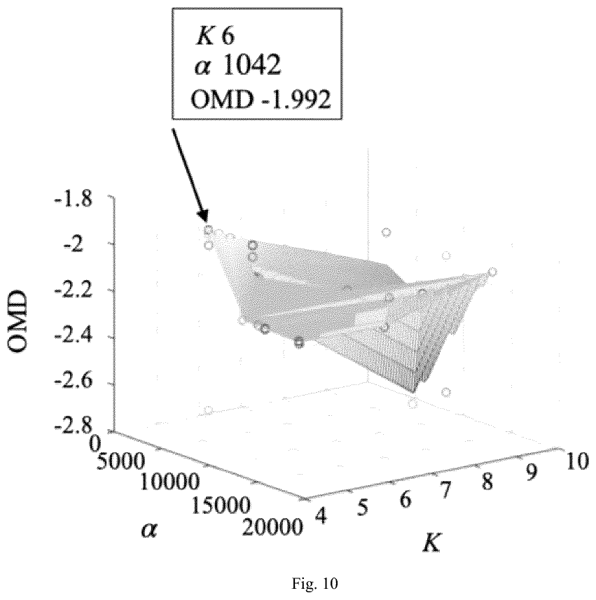

FIG. 10 is a schematic diagram of distribution of OMD relative to the changes of α and K values in the process of optimizing the group of bearing inner ring vibration signals X(t) of a CWRU laboratory public data set shown in FIG. 9. From the distribution of the fitness value OMD with the changes of α and K values, it can be seen that in the process of solving the optimization model (8) by the genetic algorithm-based solver and automatically determining the optimal VMD parameters (αₒₚₜ and Kₒₚₜ) that decompose the bearing vibration signals X(t), (K, α, OMD)=(6, 1042, −1.992) is the optimal point, the result values around the optimal point are produced by the last few iterations and eventually tend to be stable without changes, and the optimal values that decompose the bearing vibration signals X(t) are obtained, which proves that in the process of solving the optimization model by the genetic algorithm, the optimal parameters (α, K)=(1042, 6) that decompose the bearing inner ring fault vibration signals X(t) shown in FIG. 9 is gradually converged and obtained.

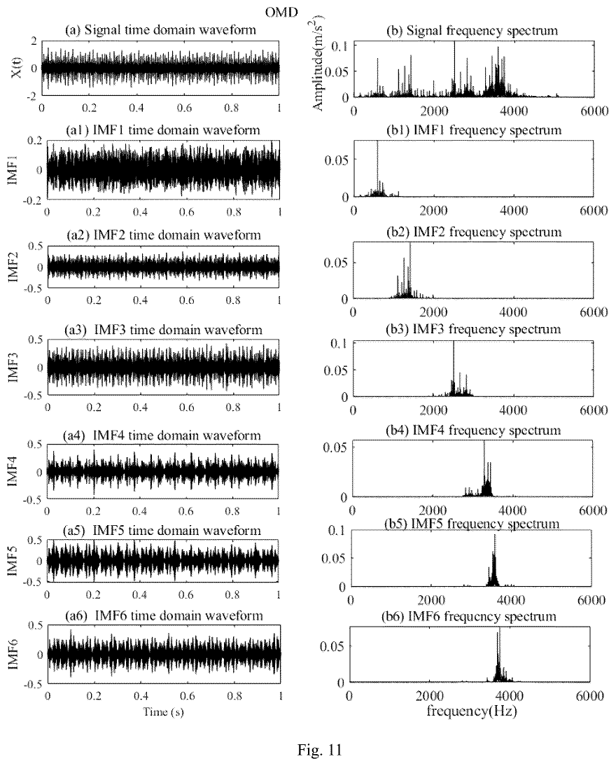

FIG. 11 shows a result diagram of decomposing the bearing inner ring fault vibration signals X(t) shown in FIG. 9 by the optimal VMD parameters (α, K)=(1042, 6). It can be seen from the figure that the time-domain waveform diagrams of the original bearing inner ring fault vibration signals X(t) shown in FIG. 9 and the intrinstic modes IMF1-IMF6 obtained by decomposition are shown in the left of the figure, the corresponding frequency spectra are shown in the right of the figure, and no under-decomposition or over-decomposition phenomenon exist in the decomposition results, which indicates that using the variational mode decomposition parameters determined by the optimization algorithm to decompose the motor bearing inner ring fault vibration signals X(t) disclosed by the CWRU laboratory of the embodiment of the present invention, an ideal decomposition result is obtained.

To further illustrate that the optimization algorithm can still automatically determine the optimal VMD parameters (αₒₚₜ and Kₒₚₜ) when decomposing actual bearing vibration signals, and has superior performance, the parameter optimization algorithm proposed by the present invention and different optimization algorithms are used to simultaneously decompose a group of motor bearing inner ring fault vibration signals X(t) disclosed by the CWRU laboratory shown in FIG. 9. The comparison of quantitative evaluation indexes of the obtained decomposition results is shown in Table 3.

TABLE 3
Comparison of quantitative evaluation indexes of bearing
vibration signal X(t) decomposition results

| Serial | | Optimization | | | |
|---|---|---|---|---|---|
| No. | Algorithm | model | Res | Δω_{K} | J |
| 1 | OMD-VMD | Equation (7) | 19.4268 | 3.7963e+05 | 128.2986 |
| 2 | Fix-VMD | — | 43.9022 | 3.4144e+05 | 162.0286 |
| 3 | MMEE- | Minimum mean | 337.2185 | 6.0221e+05 | 231.2054 |
| | VMD | envelope entropy | | | |
| 4 | BW-Δω_{K}- | Synthesis of equations | 415.4959 | 1.6127e+06 | 185.8165 |
| | VMD | (4) and (6) | | | |
| 5 | BW-Res- | Synthesis of equations | 44.8020 | 3.4149e+05 | 160.3963 |
| | VMD | (4) and (5) | | | |

An optimization algorithm for automatically determining variational mode decomposition algorithm parameters of the present invention can not only automatically determine the specific optimal decomposition parameters for artificial bearing vibration signals, but also automatically determine the corresponding optimal parameters when decomposing actual bearing vibration signals. In addition, the quantitative indexes of decomposition performance also show that the signal decomposition algorithm VMD based on the optimal parameters obtained by the optimization algorithm has good decomposition performance. It shows that the optimization algorithm for automatically determining variational mode decomposition parameters has certain advantages in determining the parameters of the bearing vibration signals decomposed by the variational mode decomposition algorithm. Therefore, based on the variational mode decomposition parameters automatically determined by the optimization algorithm, the original bearing vibration signals can be decomposed more reasonably and a group of ideal modes can be obtained. Based on the group of ideal mode components, the present invention has a positive effect on the extraction of feature information that characterizes the health status of the bearing and the improvement of the bearing failure mode identification accuracy, so the present invention is of great significance to the health management of rotating machinery equipment.

The above embodiments only express the implementation of the present invention, and shall not be interpreted as a limitation to the scope of the patent for the present invention. It should be noted that, for those skilled in the art, several variations and improvements can also be made without departing from the concept of the present invention, all of which belong to the protection scope of the present invention.

1. An optimization algorithm for automatically determining variational mode decomposition parameters based on bearing vibration signals, comprising the following steps:
(1) establishing a bandwidth optimization sub-model to obtain an optimal bandwidth parameter αₒₚₜ
mode energy is measured by self-power spectral density, bandwidth of a mode is calculated, and an optimal bandwidth parameter αₒₚₜ is obtained; the steps for obtaining the bandwidth by the self-power spectral density SPSD of the mode are as follows:
1) decomposing a signal into K modes uₖ(k=1,2, . . . K) by a classic VMD algorithm and parameter configurations K and α;
2) selecting the k^{th} mode uₖ to explain how to use SPSD to estimate the bandwidth; according to equation (1), the self-power spectral density SPSDₖ of the k^{th} mode uₖ can be obtained;
$$\{ \begin{matrix}{SPSD}_{k 1} & = {\int }_{0}^{{f}_{k 1}} {\vert {u}_{k} ( f ) \vert}^{2} df = 0. 005 {\int }_{0}^{{f}_{k}} {\vert {u}_{k} ( f ) \vert}^{2} df \\ {SPSD}_{k 2} & = {\int }_{0}^{{f}_{k 2}} {\vert {u}_{k} ( f ) \vert}^{2} df = 0. 995 {\int }_{0}^{{f}_{k}} {\vert {u}_{k} ( f ) \vert}^{2} df \\ {SPSD}_{k} & = {SPSD}_{k 2} - {SPSD}_{k 1}\end{matrix} \qquad ( 1 )$$
where SPSDₖ₁ and fₖ₁ are respectively the first 0.5% SPSD values of the mode and a corresponding frequency point; SPSDₖ₂ and fₖ₂ are respectively the last 0.5% SPSD values of the mode and a corresponding frequency point;
then the analyzed bandwidth BWₖ of the mode uₖ is:
BWₖ=fₖ₂−fₖ₁,k=1,2, . . . K (2)
according to equation (3),
$$\{ \begin{matrix}{min}_{\{ {u}_{k} \} , \{ {ω}_{k} \}} \{ {\sum }_{k - 1}^{K} {‖ {\partial }_{t} [ ( δ ( t ) + \frac{J}{π t} ) * {u}_{k} ( t ) ] {e}^{- j {ω}_{k} t} ‖}_{2}^{2} \} \\ s . t {\sum }_{k = 1}^{K} {u}_{k} = x ( t )\end{matrix} \qquad ( 3 )$$
the signal can be decomposed into several principal modes, and the sum of the bandwidths of each IMF is considered to be minimum; where K is the total number of modes, x(t) is an original signal to be decomposed, δ(t) is a Dirac distribution, and * is a convolution operator, a corresponding analytic signal uₖ(t) is calculated by Hilbert transform to obtain a unilateral frequency spectrum; subsequently, the frequency of the mode is translated to a baseband by the displacement property of Fourier transform, the bandwidth of the mode is obtained through the square of a L²-norm of gradient, and {uₖ|k=1,2, . . . K} and {ωₖ|k=1,2, . . . K} are respectively a set of all modes and the corresponding center frequencies;
therefore, a bandwidth optimization model is obtained:
$${min}_{α} B W = {‖ {f}_{2} - {f}_{1} ‖}_{2}^{2} \qquad ( 4 )$$
where BW represents the sum of the bandwidths of all modes, f₁=[f₁₁ f₂₁ . . . f_{K1}]^{T} is the left frequency point of all modes uₖ(k=1,2, . . . K), K is the number of modes obtained by decomposition, and f₂=[f₂₁ f₂₂ . . . f_{K2}]^{T} is the right frequency point: f₁₁ represents the frequency point of the first 0.5% self-power spectral density of the first mode, that is, the left frequency point of the first mode; f₁₂ represents the frequency point of the last 0.5% self-power spectral density of the first mode, that is, the right frequency point of the first mode;
(2) establishing an energy loss optimization sub-model
to avoid under-decomposition and ensure the integrity of mode reconstruction information, an energy loss optimization sub-model is established:
$${min}_{K} Res = {‖ x ( t ) - {\sum }_{k = 1}^{K} {u}_{k} ( t ) ‖}_{2}^{2} \qquad ( 5 )$$
where Res represents residual energy; and
$${\sum }_{k = 1}^{K} {u}_{k} ( t )$$
represents a mode reconstruction signal;
(3) establishing a mode mean position distance optimization sub-model:
to prevent the generation of too much K and avoid the occurrence of over-decomposition, a mode mean position distance optimization sub-model is established:
$${max}_{K} {Δω}_{K} = \frac{1}{K - 1} {\sum }_{k = 1}^{K - 1} {\vert {ω}_{k + 1} - {ω}_{k} \vert}^{2} \qquad ( 6 )$$
where ΔωK represents a mode mean position distance, ω_{K+1} represents the center frequency of the latter mode in adjacent modes, and ω_{K} represents the center frequency of the first mode in the adjacent modes;
(4) obtaining an optimal mode number Kₒₚₜ by considering the energy loss optimization sub-model and the mean position distance optimization sub-model comprehensively;
to select an appropriate total number of modes, it is not only necessary to ensure that the total number of decomposed modes is not too small to cause under-decomposition, that is, to avoid the occurrence of energy loss, but also necessary to ensure that the total number of modes is not too large to cause over-decomposition, that is, to avoid the occurrence of mode aliasing; by comprehensively considering the energy loss optimization sub-model and the mean position distance optimization sub-model:
$${min}_{K} {K}_{num} = {‖ x ( t ) - {\sum }_{k = 1}^{K} {u}_{k} ( t ) ‖}_{2}^{2} - \frac{1}{K - 1} {\sum }_{k = 1}^{K - 1} {\vert {ω}_{k + 1} - {ω}_{k} \vert}^{2}$$
an optimal mode number Kₒₚₜ can be obtained; where Kₙᵤₘ represents an objective function of an optimized mode number optimization model;
(5) to obtain the optimal VMD parameters αₒₚₜ and Kₒₚₜ of a bearing signal to be decomposed at the same time, it is necessary to consider the interaction between the bandwidth parameter α and the total number of modes K, the interaction between mode components and the integrity of reconstruction information, so the three optimization sub-models of the above step (1)-step (3) need to be satisfied at the same time; as the bandwidth optimization sub-model, the energy loss optimization sub-model and the mean position distance optimization sub-model have a large order of magnitude difference, nonlinear transformation is performed to the three optimization sub-models by a logarithmic function, so as to make the values of the three optimization sub-models form similar scales, and obtain an optimization model that can automatically determine the VMD parameters αₒₚₜ and Kₒₚₜ as shown in equation (7);
$${max}_{( K , α )} OMD = ln ( \frac{1}{K - 1} {\sum }_{k = 1}^{K - 1} {\vert {ω}_{k + 1} - {ω}_{k} \vert}^{2} ) - ln ( {‖ {f}_{2} - {f}_{1} ‖}_{2}^{2} ) - ln ( {‖ x ( t ) - {\sum }_{k = 1}^{K} {u}_{k} ( t ) ‖}_{2}^{2} ) \qquad ( 7 )$$
where OMD represents an objective function;
(6) using a genetic algorithm-based solver to solve the optimization model in step (5), and automatically determine the optimal VMD parameters αₒₚₜ and Kₒₚₜ;
$$\begin{matrix}{max}_{( K , α )} & OMD\end{matrix} \qquad ( 8 )$$
$$\begin{matrix}s . t . & K ∈ {R}_{K} ⊂ N \\ & α ∈ {R}_{α} ⊂ N\end{matrix}$$
where R_{K} and R_{α} are respectively the value ranges of K and α, and N is a set of nonnegative integers; based on the obtained optimal parameters αₒₚₜ and Kₒₚₜ, bearing vibration signals can be decomposed reasonably, which provides a basis for feature extraction and fault diagnosis based on the bearing vibration signals;
(7) establishing a quantitative evaluation index J of VMD decomposition performance to quantitatively evaluate the decomposition performance of the VMD algorithm to decompose the bearing vibration signals; the smaller the quantitative evaluation index J of VMD decomposition performance is, the better the VMD decomposition performance is.

2. The optimization algorithm for automatically determining variational mode decomposition parameters based on bearing vibration signals according to claim 1, wherein the genetic algorithm in step (6) is specifically as follows:
1) search space: a search space S⊂R_{K}×R_{α} is obtained based on the VMD parameter configurations α and K, and an individual sⱼ=(Kⱼ, αⱼ)∈S in a population is obtained by binary encoding;
2) fitness function: fitness of each individual sⱼ∈S is evaluated by the value of the objective function OMD in equation (7), and is denoted by rⱼ;
3) genetic operator: an optimal solution is obtained through iterative operations such as selection, crossover and mutation;
the probability Pⱼ of each individual sⱼ being selected is obtained by sorting selection:
$${P}_{j} = {P}_{min} + ( {P}_{max} - {P}_{min} ) \frac{j - 1}{n - 1} ,$$
$$where {P}_{min} = min \{ {P}_{j}^{*} \vert j = 1 , 2 , … n \} , {P}_{max} = max \{ {P}_{j}^{*} \vert j = 1 , 2 , … n \} , {P}_{j}^{*} = \frac{{r}_{j}}{{\sum }_{j = 1}^{n} {r}_{j}} ,$$
P*ⱼ represents the original probability of the fitness rⱼ of the individual sⱼ being selected, and n is a population size;
the crossover probability P_{c} is:
$${P}_{c} = \{ \begin{matrix}{P}_{c max} - ( {P}_{c max} - {P}_{c min} ) \frac{{r}_{max} - {r}_{j}}{{r}_{max} - {r}_{avg}} , & {r}_{cj} \geq {r}_{avg} \\ {P}_{c max} , & {r}_{cj} < {r}_{avg}\end{matrix}$$
P_{cmax} and P_{cmin} represent the lower limit and upper limit of the crossover probability respectively, r_{avg} is an average fitness of individuals in the population of the present genetic generation, r_{cj} is the larger fitness value of two individuals to be crossed over, and rₘₐₓ is the maximum fitness of individuals in the population of the present genetic generation;
the mutation probability Pₘ is:
$${P}_{m} = \{ \begin{matrix}{P}_{m max} - ( {P}_{m max} - {P}_{m min} ) \frac{{r}_{max} - {r}_{j}}{{r}_{max} - {r}_{avg}} , & {r}_{mj} \geq {r}_{avg} \\ {P}_{m max} , & {r}_{mj} < {r}_{avg}\end{matrix}$$
Pₘₘₐₓ and Pₘₘᵢₙ represent the lower limit and upper limit of the mutation probability respectively, where rₘⱼ is the fitness of a mutated individual.

3. The optimization algorithm for automatically determining variational mode decomposition parameters based on bearing vibration signals according to claim 1, wherein the quantitative evaluation index J of VMD decomposition performance in step (7) is:
$$J = \frac{{‖ {f}_{2} - {f}_{1} ‖}_{2}^{2} \cdot {‖ x ( t ) - {\sum }_{k = 1}^{K} {u}_{k} ( t ) ‖}_{2}^{2}}{\frac{1}{K - 1} {\sum }_{k = 1}^{K - 1} {\vert {ω}_{k + 1} - {ω}_{k} \vert}^{2}} \qquad ( 9 )$$
where the smaller ∥f₂−f₂∥₂² is, the narrower the decomposition bandwidth is; the smaller
$${‖ x ( t ) - {\sum }_{k = 1}^{K} {u}_{k} ( t ) ‖}_{2}^{2}$$
is, the smaller the residual energy is, and the smaller the distance between a reconstructed mode and the original signal is, that is, the higher the reconstruction degree is; the larger
$$\frac{1}{K - 1} {\sum }_{k = 1}^{K - 1} {\vert {ω}_{k + 1} - {ω}_{k} \vert}^{2}$$
is, the farther the distance between adjacent mode centers is, and the smaller the aliasing area between the adjacent modes is.
